(19) United States
(12) Patent Application Publication
(10) Pub. No.: US 2006/0193422 A1
(43) Pub. Date: Aug. 31, 2006

(54) Fuel channel characterization method and device

(76) Inventors: Michael D. Davis, Danville, VA (US); Darel R. Clark, Lynchburg, VA (US); John W. Van Bergen, Lynchburg, VA (US); Anthony Pugh, Forest, VA (US)

Correspondence Address: KENYON & KENYON LLP, ONE BROADWAY, NEW YORK, NY, 10004, US

(21) Appl. No.: 11/058,058

(22) Filed: Feb. 14, 2005

(51) Int. Cl. G21C 17/00

(52) U.S. Cl. 376/245

(57) ABSTRACT

An apparatus to measure external dimensions of a fuel channel of a boiling water reactor, having a rigid frame which has a lower seat to accept a nozzle of a nuclear fuel assembly, the rigid frame extending an entire length of the nuclear fuel assembly, an inspection arrangement including ultrasonic transducers placed upon the rigid frame, the ultrasonic transducers supported by the rigid frame, the ultrasonic transducers configured to generate and receive ultrasonic signals imparted into a medium and generate an electrical signal upon receipt of the ultrasonic signal, a signal processing arrangement configured to evaluate electrical signals received from the inspection arrangement, and a series of leads connected to the arrangement of ultrasonic transducers, the series of leads taking the electrical signals generated by the inspection arrangement of ultrasonic transducers and transporting the electrical signals from the ultrasonic transducers to the signal processing arrangement.

### FIELD OF INVENTION

The present invention relates to the field of measuring fuel assemblies through an ultrasonic measurement system. More specifically, the present invention relates to a system for non-destructive testing of a fuel assembly in order to measure the physical characteristics and dimensional behavior of irradiated boiling water reactor fuel channels using a time-domain analysis of ultrasound pulses imparted to the fuel channel to be measured.

### BACKGROUND INFORMATION

Non-destructive testing relates to the field of using non-invasive techniques to obtain information about the integrity or physical characteristics of structures. Examples of this technology include ultrasonic flaw detection in fuel cladding for nuclear fuel assemblies. Ultrasonic acoustic measurement is but one such system used for non-destructive testing of parts having an accessible surface. As sound waves travel through a medium or a part to be inspected, a portion of the energy imparted into the component will be reflected at an interface of the component which has a different refractive index. The period of time from initial transmission of the ultrasonic wave until the reflected energy has been detected from the interface is directly proportional to the location of the interface. The underlying principle upon which these ultrasonic flaw detection systems are founded is a basic physics relationship: distance=(velocity)×(time). For a homogeneous material, the velocity of sound is a constant value and is typically found through use of a reference book or determined using a known or established distance.

Ultrasonic measurements are performed in a series of steps. An ultrasonic transducer is coupled to a test piece wherein the transducer generates a high frequency acoustic sound pulse. The transducer then waits for a return pulse echo. Simultaneously with the generation of an ultrasonic pulse into the material to be tested, the system starts a clock. The ultrasonic system, which has been programmed with the speed of sound in the test material, then records the time of the return echo. Using the known velocity of the wave for the material tested and the time of flight, the overall distance to the point of reflection is calculated. The amplitude of the reflected energy is often related to shape, orientation and physical size of the interface and therefore the return echo amplitude is measured. Additional factors can also be considered in the measurement process. One additional factor is that the speed of sound in a material changes with the temperature of the material being tested. Accordingly, measurement systems must include an arrangement for compensating for temperature related changes in sound velocity in order to minimize temperature-related inaccuracies.

Industry experience has indicated that boiling water reactor fuel assembly channels undergo significant degradation when exposed to flux gradients in the nuclear reactor core. Such degradation generally involves deformation which includes bow deformation, twist deformation and bulge deformation. This deformation can lead to fuel assembly installation problems in the confines of a nuclear reactor. Additionally, when the fuel channel is removed from the exterior of a nuclear fuel assembly, the dechanneling operation may result in a stuck fuel channel, or the fuel channel may damage the underlying structure of the fuel assembly. An additional problem that may be encountered for fuel channels which have been deformed is the interaction of the fuel assembly with control rod blades which traverse the reactor. As the control rod blades travel through the reactor core, the blades can impact deformed fuel channels.

Design of the nuclear core as a whole is dependent upon the shape of the fuel assembly installed in the reactor. Fuel assembly channels which are deformed can impact the critical power ratio and capability of the reactor to maintain criticality. There are currently no methods or apparatus to measure fuel assembly overall dimensions to ensure compliance of the fuel assembly to expected design parameters. Other performance issues have also been identified with relation to nuclear fuel assembly fuel channels, e.g., hydride-induced channel bow arising from shadow-corrosion effects on control.

Additionally, measurements that are performed are done in a piece-wise manner.

There is therefore a need to provide a system to identify defects in nuclear fuel assembly fuel channels by taking external dimensions of the nuclear fuel assembly channel and comparing these measurements to fuel channel design parameters.

There is also a need to provide a system to identify defects of fuel assembly channels in a non-damaging and non-contact manner.

There is a further need to provide a system to identify defects in nuclear fuel assembly fuel channels in an economical, accurate and fast manner.

There is also a need to provide a system which will measure a boiling water reactor fuel channel in a single measurement position, without traversing along the length of the fuel assembly.

### SUMMARY

It is therefore an objective of the present invention to provide a system to identify defects in nuclear fuel assembly fuel channels by taking external dimensions of the nuclear fuel assembly channel and comparing these measurements to fuel channel design parameters.

It is also an objective of the present invention to provide a system to identify defects of fuel assembly channels in a non-damaging and non-contact manner.

It is a still further objective of the present invention to provide a system to identify defects in nuclear fuel assembly fuel channels in an economical accurate and fast manner.

It is also an objective of the present invention to provide a system which will measure a boiling water reactor fuel channel in a single measurement position, without traversing along the length of the fuel assembly.

The objectives of the present invention are achieved as illustrated and described. The present invention provides an apparatus to measure external dimensions of a fuel channel of a boiling water reactor. The apparatus provides a rigid frame which has a lower seat to accept a nozzle of a nuclear fuel assembly, the rigid frame extending an entire length of the nuclear fuel assembly, an inspection arrangement including ultrasonic transducers placed upon the rigid frame, the ultrasonic transducers supported by the rigid frame, the ultrasonic transducers configured to generate and receive ultrasonic signals imparted into a medium and generate an electrical signal upon receipt of the ultrasonic signal, a signal processing arrangement configured to evaluate electrical signals received from the inspection arrangement, and a series of leads connected to the arrangement of ultrasonic transducers, the series of leads taking the electrical signals generated by the inspection arrangement of ultrasonic transducers and transporting the electrical signals from the ultrasonic transducers to the signal processing arrangement.

The objectives of the present invention are also achieved in a method to calculate shape deviations of a fuel channel of a boiling water reactor. The method comprises the steps of providing a structure for supporting the fuel channel, imparting acoustic energy into the fuel channel while starting a timer at a beginning of the imparting of the acoustic energy, receiving acoustic energy echoing from the fuel channel, stopping the timer at the receipt of the acoustic energy, calculating a total time of flight of the acoustic energy, calculating a total distance between each transducer and the fuel channel, and comparing the calculated total distance for each transducer to a standard fuel channel.

### BRIEF DESCRIPTION OF THE DRAWINGS

FIG. 1 is a sectional view of a fuel channel measurement assembly in conformance with an exemplary embodiment of the invention;

FIG. 1A is a plan view of a fuel assembly with attached fuel channel;

FIG. 2 is a plan view of a fuel assembly seat of the fuel channel measurement assembly;

FIG. 3 is a plan view of a retaining arrangement of the fuel channel measurement assembly;

FIG. 4 is a graphical representation of bulge of a fuel assembly channel at differing elevations;

FIG. 5 is a graphical representation of twist of a fuel assembly channel at a single measurement elevation;

FIG. 6 is a graphical representation of channel bow at differing elevations;

FIG. 7 is a graphical representation of a two plane bow of a fuel channel.

### DETAILED DESCRIPTION

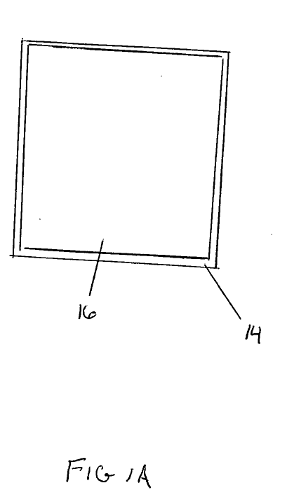

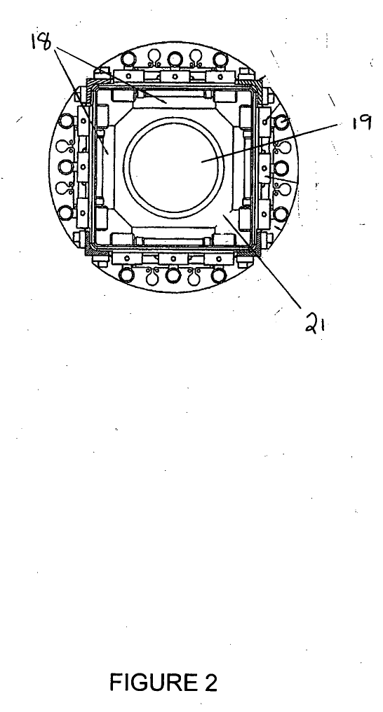

Referring to FIGS. 1 and 1A, a boiling water reactor channel measurement system 10 in conformance with the present invention is illustrated. The measurement system 10 of the present invention is comprised of a rigid support frame 12 which is used to support a series of special immersion ultrasonic transducers 20. The rigid support frame 12 is designed to allow simultaneous distance measurements of a boiling water reactor fuel channel 14, thereby allowing for precise dimensional profiling of the fuel channel 14. The rigid frame 12 is designed to interface with support structures commonly found in nuclear power plant facilities, thereby allowing placement of the rigid frame 12 in a variety of placement areas such as storage pools or reactor cavities. These support structures include fuel handling cranes and/or manipulator cranes commonly used in nuclear reactor core and spent fuel pool locations. The boiling water reactor fuel channel 14, complete with fuel assembly 16 or dechannelled (i.e. removed from the exterior of the fuel assembly), is driven into place inside the support frame 12 using a fuel manipulator crane or bridge hoist. The channel 14 is then lowered to interface with a lower seat 18 of the rigid frame 12. The lower seat 18 is illustrated in FIG. 2. The lower seat 18 allows for the acceptance of a nozzle of the fuel assembly in a lower seat hole 19. The lower seat hole 19 is constructed to accurately accept the fuel assembly lower nozzle such that the channel 14 is positioned at the bottom in a defined location. The lower seat 18 has a bearing surface 21 which provides a contact surface for the fuel assembly. The bearing surface 21 allows for load transfer of the fuel assembly to the remainder of the system 10.

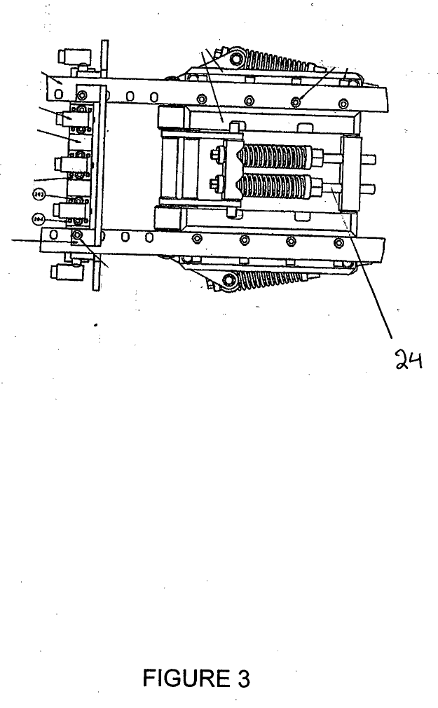

Referring to FIG. 3, spring loaded rods 24 are positioned along the length 26 of the system-10 for additional stabilization. The spring loaded rods 24 allow of the fuel assembly channel 14 to be maintained in a constant position, limiting movement during subsequent inspection. The spring loaded rods 24 are adjustable roller bearing type units. In the illustrated embodiment, two sets of spring loaded rods 24 are used to position the fuel assembly.

Referring to FIG. 1, the inspection technique of the present invention uses an ultrasonic measurement system 10 which evaluates the time of flight of signals produced by an array of opposing ultrasonic transducers strategically placed around and along the length of the inspection system 10. The placement of the ultrasonic transducers along the length of the system 10 is chosen according to identified defects found in fuel assemblies with like physical characteristics. A pulse generator 28 produces an electric signal with defined characteristics. The signal is sent to one of the array of transducers 20, a multiplexer 30, and a computer 32 programmed to track data obtained from the transducers 20. The signal produced by the pulse generator 28 is converted to an ultrasonic acoustic wave by the transducers 20, which is then aimed and transmitted at the boiling water reactor fuel channel to be measured. The transducers are a send\receive configuration data with a high quality factor (Q). In the illustrated embodiment, seven levels of ultrasonic sensors 20 are used. The transducers 20 send/receive pulses such that they are provided with an exponentially decaying oscillation of the transmit pulse allowing the oscillation sent to stop before a receipt of echo information occurs.

Measurements occur in an acoustically-coupled medium (reactor water). Echoes reflected from the interface of the boiling water reactor fuel channel return to the transducers, which convert the echo into a corresponding electrical signal. The electrical signal is then routed to a receiver, such as a computer 32, where the signals are analyzed, digitized and stored in memory. The analysis includes calculating the total time of flight of the acoustic wave. The total time of flight is then matched with the acoustic medium in which the acoustic wave traveled. A distance is then calculated for each transducer 20 around the fuel assembly knowing the time and velocity of the wave. The distance is then compared to expected values for distance of the fuel channel to the position of each transducer along the length of the system 10.

Analysis of the time of flight data showing the distance to the side of the boiling water reactor fuel channel is equated as a product of the speed of sound and the propagation time of the ultrasound wave within the medium. A quality-control measured calibration standard and\or a reference target can be used to compensate measurements for variations in temperature and salinity of the acoustic compliant medium. The system 10 may also have a temperature reading component, such as a digital thermometer to analyze the temperature of the medium. The digital thermometer may be a mercury free unit.

The system calibration procedure will involve recording ultrasonic data from the reference standard. Then, a computer with custom software compares the field-obtained ultrasonic reading (which used a nominal sound velocity not adjusted for temperature\pressure) to the mechanical quality control measured reading of the reference standard to compute a calibration constant for that ultrasonic transducer channel. The constant for each unknown irradiated boiling water reactor fuel channel uses a lookup table to incorporate this adjustment for each transducer channel.

The data acquisition system is connected to a computer with custom software that interprets received data. The design of the fuel channel and mechanically measured readings of the reference standard are entered into the software at the beginning of the measurement cycle. The field acquired data is then imported into a computer program where it is processed, corrected and converted to values for channel bow, channel bulge and channel twist. The received data, along with corrected data, is displayed on the computer 32, for example, for the operator to analyze. The data is also exported to a storage file to be printed and stored on a computer hard drive and\or compact disk for additional evaluation and graphic display.

Sample Calculations

The computer program used to evaluate the measured values requires specific data inputs in order to calculate desired values. A list of the defined parameters follows:

Transducer number=m

Measured sound path distance=xₘ, in inches
field=Xₘ−X_{cm}+(C_{D}−Cₛ)/2

where

Xₘ=sound path distance at transducer “m”

X_{cm}=sound path distance measured at “m” location on channel standard

C_{D}=design with of fuel channel at “m”

Cₛ=quality controlled measured width of channel standard at location “m”

Each transducer reading (i.e. the field measurements) is adjusted as provided below, for bow, convexity/concavity and bulge:
X′_{zAB}=X_{zAB}+(C_{Dzab-cb}−C_{Szab-cb})/2−C_{TWz}/2−C_{Bzac} (corner measurement)
X′_{zA}=X_{zAB}+(C_{Dzab-cb}−C_{Szab-cb})/2−(C_{CCza}−C_{CCzc})/2 (center measurement)

Where

z=the axial elevation of the point in question

X′_{zAB}=corrected measurement

X_{zAB}=field value

C_{Dzab-cb}=design width between points AB and CB

C_{Szab-cb}=width between points AB and CB on channel standard (QA measurement)

C_{TWz}=twist measured on channel standard

C_{Bzac}=bow measured on channel standard

C_{CCza}=concavity (−)/convexity (+) on side A

C_{CCzc}=concavity (−)/convexity (+) on side C

Channel bulge is calculated by subtracting the average at the corner locations from the width of the center location, and then dividing this result by two. As previously described, each reading is actually the deviation from an “ideal” or standardized channel with an adjustment for quality assurance measurements on the standard.

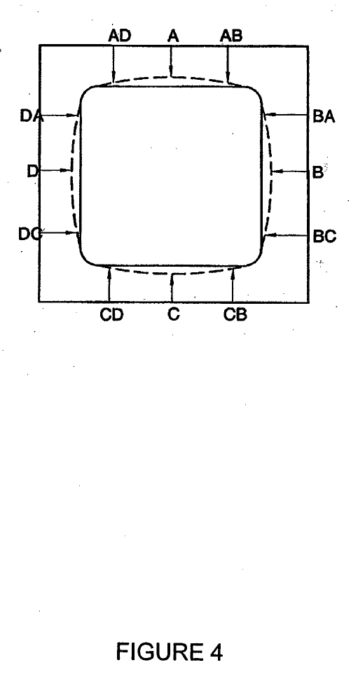

As a non-limiting example, for a bulge in the A-C direction, as provided in FIG. 4, the bulge is calculated as:
be_{zAC}=(X_{zA}+X_{zC})/2−(X_{zAD}+X_{zCD}+X_{zAB}+X_{zCB})/4

For elevations where there are no corner transducers, the reference is determined by interpolating between the corner widths as determined from the elevations above and below the elevation of interest. The bulge of values in two directions are averaged to provide one value at each elevation.

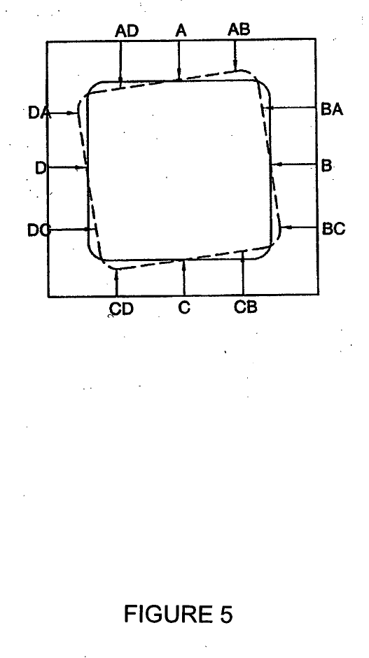

Referring to FIG. 5, twist is calculated by subtracting the differences between corner readings on a side at a particular elevation and then subtracting the corner reading difference at the lower tie plate or elevation 1.

For example, for side A:
tW_{zA}=(X_{zAD}−X_{zAB})−(X_{1AD}−X_{1AB})

The twist is calculated for all four sides on average to assign a single twist value at elevations 3, 5 and 7 for example. The twist value is not calculated at other elevations where there are no corner transducers.

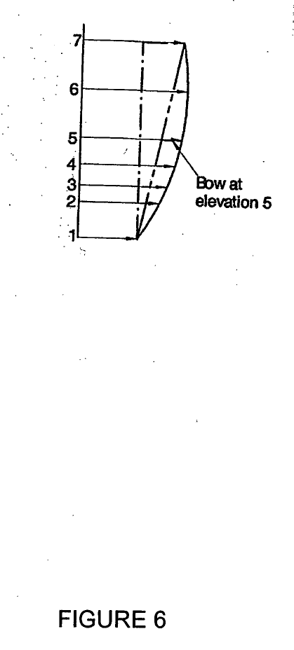

Referring to FIG. 6, bow is calculated by examining the relative measurements of each transducer in a single line (e.g., 1AB, 3AB, 5AB, 7AB).

The following equation is used:
Bw_{zAB}=(X_{1AB}−X_{zAB)})+(Z_{Z}−Z₁)/(Z₇−Z₁)−Z₁*(X_{7AB}−X_{1AB})

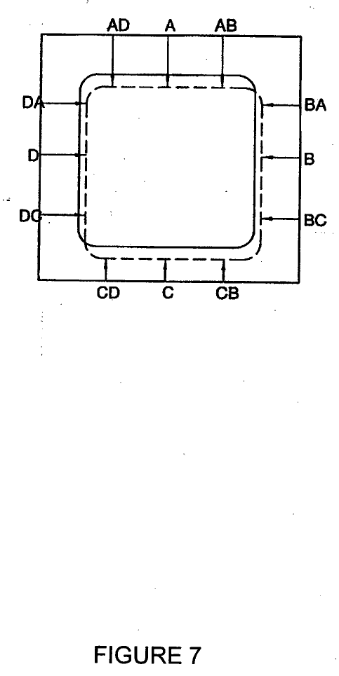

The bow is not calculated at the center transducers. The bow values at each elevation are averaged for each side. Then the two opposing sides are averaged. The result is a bow profile in two directions, A-C and D-B, as provided in FIG. 7. The total deformation is the sum of the bow and bulge. Twist is not included in the sum of the bow and bulge. A warning is displayed on the computer 32, either visually or through printed medium, if a channel reading appears to be defective and is significantly outside of expected parameters. This analysis is done by evaluating the readings of opposing transducer pairs. In this case, the computer program automatically uses the transducers at other elevations to correct the erroneous reading to an expected value if the defective reading will significantly impact the results provided. It is understood that other linear and/or curve fitting techniques can be employed to achieve an even more accurate solution and therefore use of these techniques is considered to be well within the scope of the invention as contemplated herein. In addition, reference time values obtained from repeated measurements at the same location may be averaged to obtain a more representative time of flight value from which to calculate the resulting distance. Lastly, since a digital representation of the echo signals for all measure channels are permanently stored, the data can be used to evaluate various other interrelations to provide an additional measure of security of the reliability of the measured data. Thus, a permanent record of each evaluation performed may be recalled at any time for subsequent analysis as well as using previously obtained data in subsequent data sampling sessions using the system 10 (i.e. repeated testing of the fuel channel).

The current invention provides many advantages over simple visual inspection techniques currently used to evaluate the condition of a fuel channel. The current invention allows for a fuel assembly fuel channel to be inspected in as little as one minute, minimizing inspection time as well as nuclear power plant outage duration. This advantage greatly enhances the economic viability of a nuclear power plant utilizing this technology. The system 10 is low maintenance and can be easily decontaminated, allowing for the system 10 to be moved from location to location, thereby alleviating the need for building multiple inspection systems 10. The data obtained from the system 10 can be retained for reference such that subsequent evaluations can identify changes in fuel assembly channels which occur between inspection periods. The system 10 also provides for moving the individual transducers 20 along the axis of the system 10 allowing greater or lesser concentration of inspections over a defined area. The fabrication of the system 10 is also economical in that standard components of structural steel, such as stainless steel tubing, may be used.

The system also performs an analysis of the nuclear fuel channel in a non-damaging manner. The system 10 limits contact with the fuel channel, thereby minimizing corrosion or other mechanical defects which may arise from excessive physical contact with the body of the fuel assembly. The current system 10 allows for a target accuracy of channel measurement to be within plus or minus 0.010″ (±0.254 mm). The fuel remains grappled and supported by the refueling mast at all times during examination, therefore eliminating considerations related to heavy load drop. The system 10 may also be equipped with a camera, thereby allowing visual identification of features during evaluation times. The system 10 may be suspended from a fuel pool side curb, as a non-limiting example, of a typical installation. If the system 10 were to be suspended from the fuel pool curb, a seismic evaluation of the system 10 could be accomplished such that in the event of a seismic event, the system 10 would not become loose.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. An apparatus to measure external dimensions of a fuel channel of a boiling water reactor, comprising:
a rigid frame which has a lower seat to accept a nozzle of a nuclear fuel assembly, the rigid frame extending an entire length of the nuclear fuel assembly;
an inspection arrangement including ultrasonic transducers placed upon the rigid frame, the ultrasonic transducers supported by the rigid frame, the ultrasonic transducers configured to generate and receive ultrasonic signals imparted into a medium and generate an electrical signal upon receipt of the ultrasonic signal;
a signal processing arrangement configured to evaluate electrical signals received from the inspection arrangement; and
a series of leads connected to the arrangement of ultrasonic transducers, the series of leads taking the electrical signals generated by the inspection arrangement of ultrasonic transducers and transporting the electrical signals from the ultrasonic transducers to the signal processing arrangement.

2. The apparatus according to claim 1, wherein the signal processing arrangement is a computer with an internal clock to measure time differences between activation of an ultrasonic transducer and a receipt of an echo of the activation of the ultrasonic transducer.

3. The apparatus according to claim 1, wherein the inspection arrangement comprises:
a plurality of transmitters, the transmitters configured to transmit pulses of electrical energy to energize a transducer coupled to the transmitter

4. A method to calculate shape deviations of a fuel channel of a boiling water reactor, comprising:
providing a structure for supporting the fuel channel;
imparting acoustic energy into the fuel channel while starting a timer at a beginning of the imparting of the acoustic energy;
receiving acoustic energy echoing from the fuel channel;
stopping the timer at the receipt of the acoustic energy;
calculating a total time of flight of the acoustic energy;
calculating a total distance between each transducer and the fuel channel; and
comparing the calculated total distance for each transducer to a standard fuel channel.

5. The method according to claim 4, wherein the step of comparing the calculated total distance for each transducer to a standard fuel channel encompasses at least one of calculating a bulge, bend and twist of the fuel channel to the standard fuel channel.

6. The method according to claim 4, wherein the step of calculating the total distance between each transducer and the fuel channel comprises the steps of inputting a material medium type in which the acoustic energy will travel.

7. The method according to claim 4, further comprising:
visually displaying the distances measured by each of the transducers.

8. The method according to claim 7, further comprising:
visually displaying design values for a standard fuel channel simultaneously with the distances measured by each of the transducers.

9. The method according to claim 4, further comprising:
correcting the calculated total distance for each transducer to a standard fuel channel based on a temperature and salinity of a fluid surrounding the fuel channel.

10. A method to calculate shape deviations of a fuel channel of a boiling water reactor, comprising:
providing a structure for supporting the fuel channel;
imparting acoustic energy into the fuel channel while starting a timer at a beginning of the imparting of the acoustic energy;
receiving acoustic energy echoing from the fuel channel;
stopping the timer at the receipt of the acoustic energy;
calculating a total time of flight of the acoustic energy;
calculating a total distance between each transducer and the fuel channel; and
comparing the calculated total distance for each transducer to a standard fuel channel, wherein overall dimensions of the fuel channel are measured in a single impartation of acoustic energy.

11. The method according to claim 10, wherein the step of comparing the calculated total distance for each transducer to a standard fuel channel encompasses at least one of calculating a bulge, bend and twist of the fuel channel to the standard fuel channel.

12. The method according to claim 10, further comprising:
correcting the calculated total distance for each transducer to a standard fuel channel based on a temperature and salinity of a fluid surrounding the fuel channel
